(19) United States
(12) Patent Application Publication
(10) Pub. No.: US 2026/0319539 A1
(43) Pub. Date: Oct. 15, 2026

(54) Temperature Sensor With Series Resistance Cancellation and Beta Compensation

(71) Applicant: TEXAS INSTRUMENTS INCORPORATED, Dallas, TX (US)

(72) Inventors: Ritesh Waykole, Tucson, AZ (US); Biraja Dash, Tucson, AZ (US); Timothy Buechler, Tucson, AZ (US); Sai Bharadwaj Medapuram, Tucson, AZ (US)

(21) Appl. No.: 19/175,867

(22) Filed: Apr. 10, 2025

(51) Int. Cl. G05F 3/22

(52) U.S. Cl. CPC G05F 3/225

(57) ABSTRACT

An apparatus includes a current source circuit having an output coupled to a first terminal. A first resistive device is coupled between second and third terminals. A second resistive device is coupled between the first and second terminals. A control circuit coupled to the current source circuit and to the first and second resistive devices. The control circuit is configured to enable the first resistive device and control the current source circuit to provide a first current to the first terminal; and to enable the second resistive device and control the current source circuit to generate a second current to the first terminal, the second current being different than the first current.

### BACKGROUND

A technique for measuring temperature is through the use of a temperature-sensitive device such as a bipolar junction transistor (BJT). For a BJT, the base-to-emitter voltage (Vbe) is directly proportional to the transistor's thermal voltage Vt. The thermal voltage Vt for a BIT is

$$\frac{kT}{q}$$

where k represents the Boltzmann constant, T represents temperature, and q represents the charge of an electron. By forcing a current to flow through a BJT, its Vbe can be measured and temperature calculated from its Vbe.

### SUMMARY

In one example, an apparatus includes a current source circuit having an output coupled to a first terminal. A first resistive device is coupled between second and third terminals. A second resistive device is coupled between the first and second terminals. A control circuit coupled to the current source circuit and to the first and second resistive devices. The control circuit is configured to enable the first resistive device and control the current source circuit to provide a first current to the first terminal; and to enable the second resistive device and control the current source circuit to generate a second current to the first terminal, the second current being different than the first current.

In another example, an apparatus includes a first current source having an output coupled to a first terminal. A second current source has an output coupled to the first terminal. A third current source has an output coupled to the first terminal. A first controllable resistive device is coupled between a second terminal and a ground terminal. The first controllable resistive device has a first resistance. A second controllable resistive device is coupled between the second terminal and the ground terminal. The second controllable resistive device has a second resistance different from the first resistance. A third controllable resistive device is coupled between the second terminal and the ground terminal. The third controllable resistive device has a third resistance different from the first and second resistances. An analog-to-digital converter (ADC) has an input coupled to the first terminal.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a circuit schematic of a temperature sensor, in accordance to an embodiment of the present disclosure;

FIG. 2 is a circuit schematic of a temperature sensor, in accordance to an embodiment of the present disclosure;

FIG. 3 is a circuit schematic of a temperature sensor, in accordance to an embodiment of the present disclosure; and

FIG. 4 is a circuit schematic of a temperature sensor, in accordance to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

In an example, a temperature sensor may include a bipolar junction transistor (BJT) coupled to a circuit. The circuit causes current to flow through the BJT and measures the resulting Vbe of the BJT. In one example, the emitter and the base of a PNP BJT are coupled to the circuit, and the collector is coupled to ground. The circuit forces current to flow into the emitter (Ie) of the PNP BJT resulting in current flowing out of the BJT's base (Ib) and collector (Ic). The sum of the base and collector currents equals the emitter current, Ie=Ib+Ic. The current gain, beta (β), of the BJT is the ratio of the collector current to the base current,

$$β = \frac{Ic}{Ib} .$$

Several complications may reduce the accuracy of the determination of temperature using the BJT. First, a series resistance, Rs, may be present between the circuit and the BJT's emitter. Series resistance Rs may include a physical resistor and/or the parasitic resistance of traces on a printed circuit board (PCB) between the circuit and the BJT's emitter. The current into the emitter of the BJT also flows through the series resistance Rs thereby causing a voltage drop across the series resistance Rs. The voltage that the circuit measures is the sum of the Vbe of the BJT and the voltage drop across the series resistance Rs. The magnitude of the series resistance Rs is not necessarily known apriori by the circuit that determines temperature of the BJT. Accordingly, the presence of the series resistance can affect the accuracy of the temperature value determined by the circuit. A second problem involves the beta (β) of the BJT. The beta of the BJT may vary based on the BJT's collector current. The relationship between beta and collector current may not be linear. That the BJT's beta may be a different value for different levels of collector current may also contribute to temperature determination inaccuracy.

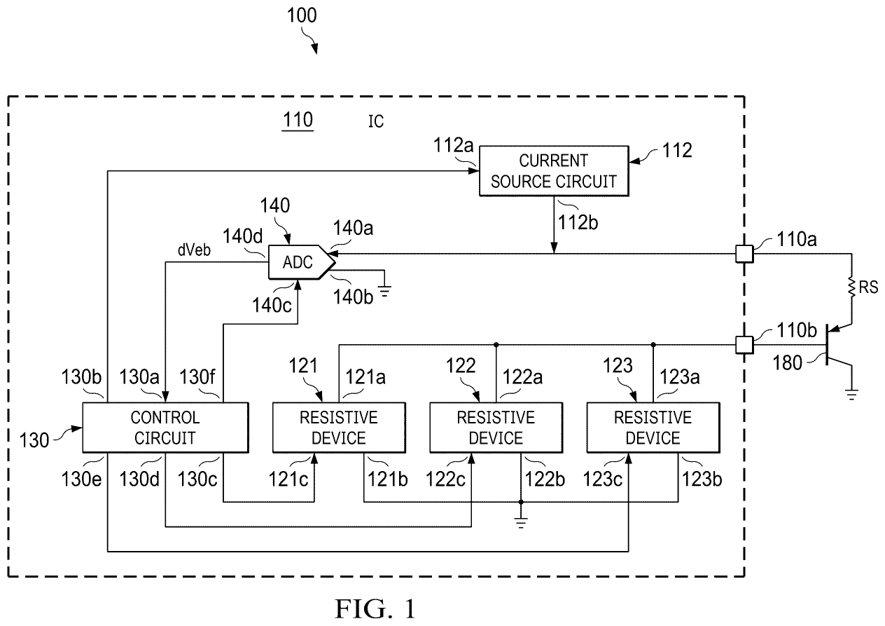

FIG. 1 is a schematic diagram of a temperature determination system 100, according to an embodiment of the present disclosure. Temperature determination system 100 includes a BJT 180 coupled to terminals 110a and 110b of an integrated circuit (IC) 110. BJT 180 is a temperature-sensitive device. In the example of FIG. 1, BJT 180 is a PNP BJT. The emitter of BJT 180 is coupled to terminal 110a. The base of BJT 180 is coupled to terminal 110b. The collector of BJT is coupled to ground. Other types of temperature-sensitive devices may be used in place of BJT 180. Examples of other types of temperature-sensitive devices include NPN BJTs, diodes, etc.

The circuitry of IC 110 determines the temperature of BJT 180, e.g., as described below. In one example, IC 110 and BJT 180 are mounted on a PCB. Series resistance Rs may be or may include the parasitic resistance of a trace on the PCB between terminal 110a and the emitter of BJT 180. A physical resistor may be included on the PCB between terminal 110a and the BJT's emitter, in which case the series resistance is or includes the resistance of such as a resistor. In some examples, BJT 180 is a transistor within an IC (e.g., a processor) other than IC 110. In such examples, IC 110 may determine the temperature of another IC.

IC 110 includes a current source circuit 112, controllable resistive devices (also called resistive devices) 121, 122, and 123, a control circuit 130, and an analog-to-digital converter (ADC) 140. Current source circuit 112 has a control input 112a and an output 112b. The output 112b is coupled to terminal 110a of IC 110. ADC 140 has inputs 140a and 140b, a control input 140c, and an output 140d. Terminal 110a is coupled to input 140a. Input 140b is coupled to ground. Control circuit 130 has an input 130a and control outputs 130b, 130c, 130d, 130e, and 130f. Output 140d of ADC 140 is coupled to input 130a of control circuit 130. Resistive device 121 has terminals 121a and 121b and a control input 121c. Resistive device 122 has terminals 122a and 122b and a control input 122c. Resistive device 123 has terminals 123a and 123b and a control input 123c. Terminals 121a, 122a, and 123a are coupled to terminal 110b of IC 110. Terminals 121b, 122b, and 123b are coupled to ground. Control output 130f of control circuit 130 is coupled to control input 140c of ADC 140. Control outputs 130c, 130d, and 130e are coupled to control inputs 121c, 122c, and 123c, respectively, of resistive devices 121, 122, and 123. In the example of FIG. 1, IC 110 includes three resistive devices 121-123. In other examples, the number of resistive devices can be different than three, for example, two resistive devices or four or more resistive devices, etc.

Resistive device 121 can be enabled to impose a resistance between its terminals 121a and 121b based on a control signal from control circuit 130 at its control input 121c. In an example, resistive device 121 imposes a resistance between terminals 121a and 121b in response to a control signal at control input 121c being at a first logic state (e.g., logic high). In response to the control signal being at a second logic state (e.g., logic low), resistive device 121 represents an open circuit between terminals 121a and 121b. Similarly, resistive devices 122 and 123 can be enable to impose a resistance or an open circuit between their respective terminals 122a/122b and 123a/123b in response to control signals from control circuit 130 at the respective control inputs 122c and 123c.

In some embodiments, control circuit 130 may be implemented as a generic or custom processor or controller that has or is coupled to memory and is configured to execute instructions in such memory (e.g., to perform the functionality described herein). Control circuit 130 may also be implemented as, or include, hardware accelerators and/or state machines (e.g., to perform the functionality described herein). In some embodiments, control circuit 130 may be implemented as a programmable circuit such as a field programmable gate array (FPGA) (e.g., to perform the functionality described herein). In some embodiments, control circuit 130 is a non-programmable, digital circuit.

In some embodiments, in response to a control signal from control circuit 130 at the ADC's control input 140c, ADC 140 samples and converts an input voltage (e.g., relative to ground) from terminal 110a at input 140a into a digital value. For example, based on a technique described below, ADC 140 determines a digital value (dVeb) indicative of, for example proportional to, a temperature of BJT 180, e.g., based on multiple analog-to-digital conversions of the voltage at input 140a, each conversion based on a current from current source circuit 112 to BJT 180. Digital value dVeb is provided to control circuit 130 and can be retrieved by another device (e.g., another IC).

In some embodiments, temperature determination system 100 determines the temperature of BJT 180 while cancelling the effects of a voltage that develops across series resistance Rs when current from current source circuit 112 flows into the emitter of BJT 180. Current source circuit 112 provides two or more currents of different magnitudes to the emitter of BJT 180 in response to control signals at its control input 112a from control circuit 130. In one example, current source circuit 112 provides three currents of different magnitudes to the emitter of BJT 180 in response to control signals from control output 130b of control circuit 130. For example, current source circuit 112 may generate currents I1, I6, and I16 by which 16 is six (6) times as large as current I1, and I16 is sixteen (16) times as large as current I1.

Ignoring resistive devices 121-123 and assuming terminal 110b is coupled to ground, through control signals at its control outputs 130b and 130f, control circuit 130 can control current source circuit 112 to produce any of the three currents I1, I6, and I16 and cause ADC 140 to sample and digitize the resulting voltage difference between terminal 110a and ground. The voltage between terminal 110a and ground is the sum of the voltage drop across the series resistance Rs and the Vbe of BJT 180. For current I1 from current source circuit 112, the voltage between terminal 110a and ground is referred to as Vbe1. Similarly, for currents I6 and I16, the voltage between terminal 110a and ground is referred to as Vbe6 and Vbe16, respectively. In some embodiments, control circuit 130 determines the temperature, e.g., indicated by BJT 180 while cancelling the series resistance Rs. For each time that control circuit 130 controls current source circuit 112 to generate current I16, the control circuit 130 may control the current source circuit 112 to generate current I6 three times and controls current source circuit 112 to generate current I1 two times. Under control of control circuit 130, ADC 140 samples the voltage of terminal 110a each time one of the currents I1, I6, and I16 is generated. Accordingly, for each temperature determination, ADC determines Vbe1 two times, determines Vbe6 three times, and determines Vbe16 one time. As an integrating ADC, ADC 140 subtracts the sum of the two Veb1's from Veb16 and also subtracts the sum of the three Veb6's from Veb16. Mathematically, the subtraction can be represented as Eq. (1) below:

dVeb=2×[(Veb6−Veb1)+(I6−I1)×Rs]−[(Veb16−Vb6)+(I16−I6)×Rs] (Eq. 1)

The equation for Veb of a BJT may be given by:

$$Veb = n V t * ln ( \frac{Ic}{Is} ) \qquad ( Eq . 2 )$$

where n represents the ideality factor (typically between 1 and 2), Is represents the saturation current of the BJT, Vt represents the thermal voltage, and Ic represents the collector current. Substituting Eq. (2) into Eq. (1) results in:

dVeb=nVt*ln(13.5) (Eq. 3)

Control circuit 130 may determine the temperature of BJT 180 using Eq. (3) by, for example, dividing dVeb from ADC 140 by ln (13.5) to determine the value of “n*Vt” and then computing the temperature from the formula of the thermal voltage (kT/q).

Equation (3) is based on the assumption that the beta of BJT 180 is constant across different values for the collector current of BJT 180. As noted above, the beta can vary based on the collector current Ic of BJT 180. Varying the emitter current causes the collector current to vary. An additional term can be introduced into Eq. (3) to account for beta variability based on the various emitter currents I1, I6, and I16 of FIG. 1, as shown below in Eq. (4):

$$dVeb = nVt * ln ( 13. 5 ) + nVt [ 3 ln ( \frac{{β}_{6}}{{β}_{6} + 1} ) - 2 ln ( \frac{{β}_{1}}{{β}_{1} + 1} ) - ln ( \frac{{β}_{16}}{{β}_{16} + 1} ) ] \qquad ( Eq . 4 )$$

where β₁ is the beta value of BJT 180 for current I1, β₆ is the beta value for current I6, and β₁₆ is the beta value for current I16. The term

$$nVt [ 3 ln ( \frac{{β}_{6}}{{β}_{6} + 1} ) ]$$

represents the error introduced into dVeb based on β₆. Similarly, the terms

$$- nVt [ 2 ln ( \frac{{β}_{1}}{{β}_{1} + 1} ) ] and - nVt [ ln ( \frac{{β}_{16}}{{β}_{16} + 1} ) ]$$

represent the error in dVeb based on β₆ and β₁₆. Considering the resistive devices 121-123, the base current from BJT 180 flows through one of the three resistive devices 121, 122, and 123 in response to the particular current I1, I6, or I16 generated by current source circuit 112 that is provided to the emitter of BJT 180. For example, when control circuit control 130 controls current source circuit 112 to produce current I1, control circuit 130 also enables resistive device 121 and disables resistive devices 122 and 123. Similarly, when control circuit control 130 controls current source circuit 112 to produce current I6, control circuit 130 also enables resistive device 122 and disables resistive devices 121 and 123. When control circuit control 130 controls current source circuit 112 to produce current I16, control circuit 130 also enables resistive device 123 and disables resistive devices 121 and 122. The resulting voltage across the particular resistive device 121-123 that is enabled by control circuit 130 is included as part of the voltage received by input 140a of ADC 140. ADC 140 receives the voltage between terminal 110a and ground, which includes the sum of the Vbe of BJT 180 and the voltage across the enabled resistive device 121-123. The resulting voltage dVeb, including the voltages across the resistive devices 121-123 is:

$$dVeb = nVt * ln ( 13.5 ) + nVt [ 3 ln ( \frac{{β}_{6}}{{β}_{6} + 1} ) - 2 ln ( \frac{{β}_{1}}{{β}_{1} + 1} ) - ln ( \frac{{β}_{16}}{{β}_{16} + 1} ) ] + [ \frac{3 * I 6}{{β}_{6} + 1} * R\_ 122 - \frac{2 * I 1}{{β}_{1} + 1} * R\_ 121 - \frac{I 16}{{β}_{16} + 1} * R\_ 123 ] \qquad ( Eq . 5 )$$

where R_121, R_122, and R_123 represent the resistances of resistive devices 121, 122, and 123, respectively.

The resistance of each resistive device 121-123 can be determined in any of multiple manners, such as through the use of the following equation:

$${R}_{b} = \frac{( 1 + β )}{{I}_{e}} nVt [ 3 ln ( 1 + \frac{1}{β} ) \qquad ( Eq . 6 )$$

where R_{b} represents the resistance of one of resistive devices 121, 122, 123 for a given emitter current Ie, and Ie is one of currents I1, I6, and I16. For example, the resistance of resistive device 121 can be calculated assuming a particular value of beta and for Ie equal to I1. Upon the resistance of resistive device 121 being calculated for that particular value of beta, the resistance of resistive devices 122 and 123 can then be calculated for the same value of beta. The resistance of resistive device 122, which is enabled for current I6, is one-sixth the resistance of resistive device 121. Similarly, the resistance of resistive device 123, which is enabled for current I16, is one-sixteenth the resistance of resistive device 121. That particular set of resistances for resistive devices 121-123 is calculated for a particular beta value.

In addition to beta being dependent on collector current, beta may also have a temperature dependence. For example, beta may increase with increasing temperature. All else being equal, a larger beta for a given emitter current causes a smaller resulting base current from BJT 180. The decrease in base current can be compensated, to some extent, by implementing the resistances of the resistive devices 121-123 to have a positive temperature coefficient, thereby resulting a voltage drop that remains approximately the same despite the decrease base current. For example, in some embodiments, the resistances R_121, R_122, and R_123 in Eq. (5) above may have a positive to absolute temperature (PTAT) dependence. In this example, the current source circuit 112 may generate currents I1, I6, and I16 with little, if any, temperature dependence by, for example, applying a bandgap voltage (which has little, if any, temperature dependence) to a resistor to generate a current. The resulting temperature-independent current can be provided to a current mirror to produce currents I1, I6, and I16,

In some embodiments, the current source circuit 112 is implemented to have a positive temperature dependence on the currents I1, I6, and I16 generated therefrom to compensate for a temperature dependence of beta on BJT 180. With the currents being PTAT currents and the resistances R_121, R_122, and R_123 having little if any dependence on temperature, Eq. (5) can be rewritten as:

$$dVeb = nVt * ln ( 13.5 ) + nVt [ 3 ln ( \frac{{β}_{6}}{{β}_{6} + 1} ) - 2 ln ( \frac{{β}_{1}}{{β}_{1} + 1} ) - ln ( \frac{{β}_{16}}{{β}_{16} + 1} ) ] + \frac{nVt * ln ( constant )}{R b i a s} * [ \frac{3 * I 6}{{β}_{6} + 1} R\_ 122 - \frac{2 * I 1}{{β}_{1} + 1} * R\_ 121 - \frac{I 16}{{β}_{16} + 1} * R\_ 123 ] \qquad ( Eq . 7 )$$

where “constant” represents, as the name states, a constant value, and Rbias represents a resistor to which dVeb is applied to generate a bias current. This bias current has a positive temperature coefficient and, as described above, can be applied to a current mirror to generate the currents I1, I6, and I16,

The variation of beta may be particularly pronounced in terms of its effects on the accuracy of the temperature measurement for a fairly narrow range of beta values. For example, the variation of beta values between 2 and 10 may be significant in terms of the accuracy of the temperature measurement. The voltage resulting across the resistive devices 121, 122, and 123 reduces the temperature measurement error that would otherwise be the case absent resistive devices 121-123. For beta values greater than, for example, 10, the voltages across resistive devices 121-123 may contribute relatively little to the further reduction in temperature measurement error. For beta values less than, for example, 1, the temperature measurement error may not be significantly improved through the inclusion of resistive devices 121-123. Accordingly, in some embodiments, the resistances of resistive devices 121-123 are determined for a beta within a range of values, for example, between 1 and 10.

In some embodiments, BJT 180 may be a discrete temperature sensing device. In some embodiments, BJT 180 is part of an integrated circuit, such as a processor or application specific integrated circuit (ASIC), for example, where the BJT 180 is used to determine a (e.g., internal) temperature of the integrated circuit.

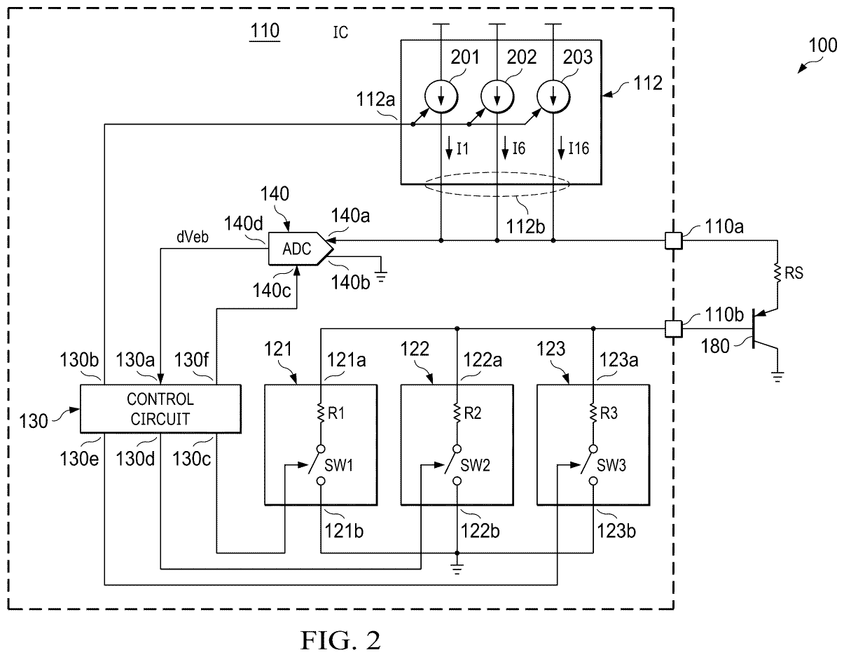

FIG. 2 is a circuit schematic similar to that of FIG. 1 but illustrating additional detail for current source circuit 112 and resistive devices 121-123. In this example, current source circuit 11 includes a current source 201, a current source 202, and a current source 203. When enabled by control circuit 130, current sources 201, 202, and 203 provide currents I1, I6, and I16, respectively. Resistive device 121 includes a resistor R1 coupled in series with a switch (e.g., a transistor) SW1 between terminals 121a and 121b. Resistive device 122 includes a resistor R2 coupled in series with a switch (e.g., a transistor) SW2 between terminals 122a and 122b. Resistive device 123 includes a resistor R3 coupled in series with a switch (e.g., a transistor) SW3 between terminals 123a and 123b. Control outputs 130c, 130d, and 130e from control circuit 130 are coupled to respective control terminals of switches SW1-SW3 (e.g., to gates of transistors implementing switches SW1-SW3). Accordingly, control circuit 130 can open or close any of switches SW1-SW3 to enable the respective resistive device 121, 122, or 123. When control circuit 130 enables current source 201, control circuit 130 also turns on switch SW1 and turns off switches SW2 and SW3. When control circuit 130 enables current source 202, control circuit 130 also turns on switch SW2 and turns off switches SW1 and SW3. When control circuit 130 enables current source 203, control circuit 130 also turns on switch SW3 and turns off switches SW1 and SW2.

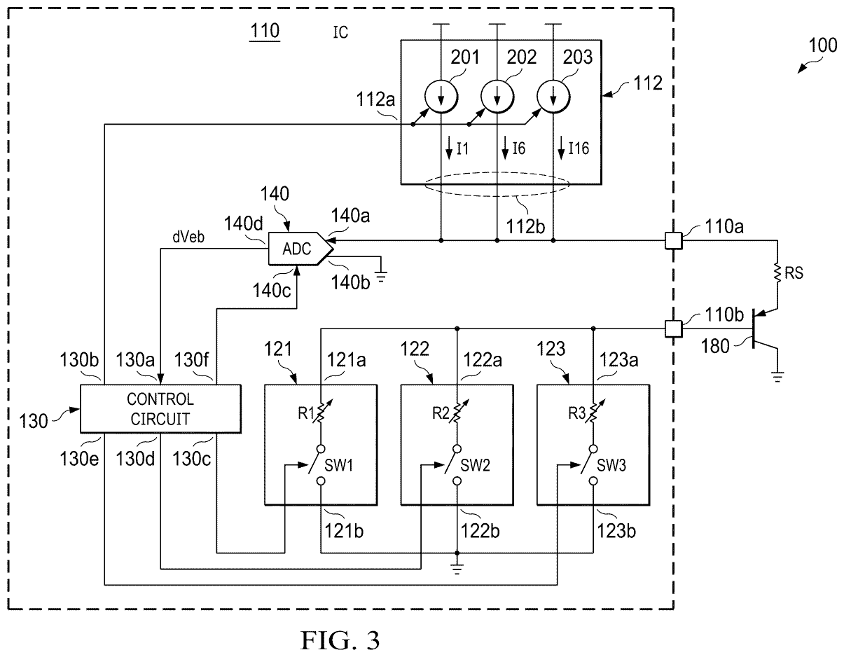

FIG. 3 is largely the circuit schematic as that of FIG. 2. FIG. 3 illustrates that resistors R1, R2, and R3 may be trimmable, as indicated by the arrows through the resistors. As described above, the resistances for resistors R1-R3 are determined for a particular beta value (e.g., β=5) within a relatively narrow range. Resistors R1-R3 can be trimmed for a different beta value. In one example, IC 150 may have a programmable register by which different values of resistors R1-R3 can be specified based on an external control value (e.g., provided over an inter-integrated circuit (IIC) interface). Each resistor R1, R2, and R3 can be configured for any of multiple resistive devices, for example, by a series and/or parallel combination of resistors and switches.

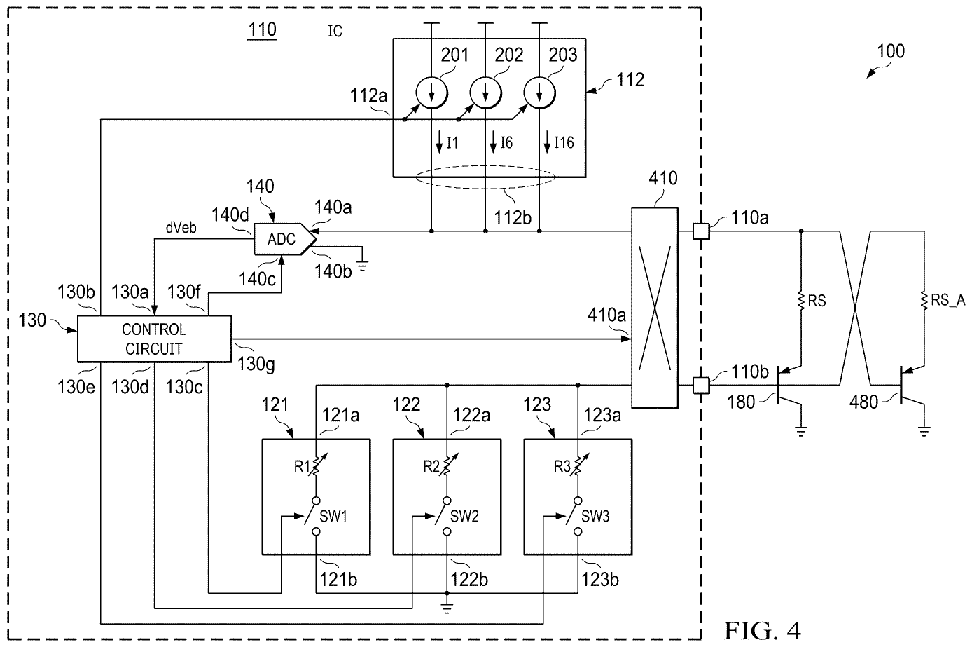

FIG. 4 is a circuit schematic of the temperature determination system 400 of FIG. 3 but with two BJTs 180 and 480 coupled to terminals 110a and 110b of IC 110. BJT 480 also is a PNP BJT. Series resistance RS_A (physical resistor and/or parasitic resistance as described above) is between terminal 110b and the emitter of BJT 480. As described above, the emitter and base of BJT 180 are coupled to terminals 110a and 110b, respectively. The emitter and base of BJT 480 are coupled to terminals 110b and 110a, respectively. IC 110 also includes a switch circuit 410. Switch circuit 410 couples output 112b of current source circuit 112 to either terminal 110a or terminal 110b, based on a control circuit from a control output 130g of control circuit 130 to a control input 410a of switch circuit 410.

Switch circuit 410 operates in one of two states based on the control signal at control input 410a. A first state includes current from current source circuit 112 being provided through switch circuit 410 to terminal 110a and to the emitter of BJT 180 while the base current from BJT 180 flows through terminal 110b, switch circuit 410, and to the enabled resistive device 121-123. In this state with current flowing out of terminal 110a, BJT 480 is off. A second state includes current from current source circuit 112 being provided through switch circuit 410 to terminal 110b and to the emitter of BJT 480 while the base current from BJT 480 flows through terminal 110a, switch circuit 410, and to the enabled resistive device 121-123. In this state with current flowing out of terminal 110b, BJT 180 is off.

As is the case for BJT 180, BJT 480 is a temperature-sensitive device whose Vbe is proportional to its temperature. With multiple BJTs 180 and 480, a single IC 110 and its circuitry can sequentially determine the temperature of each of BJTs 180a and 480. For example, the above-described technique can be employed to determine the temperature of BJT 180, and then the same technique can be employed to determine the temperature of BJT 480. Accordingly, two temperature-sensitive devices can be coupled to the same pair of terminals 110a and 110b and the temperature of each temperature-sensitive device can be determined while cancelling the associated series resistance (RS for BJT 180, and RS_A for BJT 480) and reducing the effects of beta variation, as described above. In one examples, BJTs 180 and 480 are in the same IC, albeit a different IC than IC 110.

Example embodiments of the present disclosure are summarized here. Other embodiments can also be understood from the entirety of the specification and the claims filed herein.

Example 1. An apparatus, including: a current source circuit having an output coupled to a first terminal; a first resistive device coupled between second and third terminals; a second resistive device coupled between the first and second terminals; and a control circuit coupled to the current source circuit and to the first and second resistive devices, the control circuit configured to: enable the first resistive device and control the current source circuit to provide a first current to the first terminal; and enable the second resistive device and control the current source circuit to generate a second current to the first terminal, the second current being different than the first current.

Example 2. The apparatus of example 1, where the second current is six times the first current.

Example 3. The apparatus of one of examples 1 or 2, where the control circuit is configured to: control the current source circuit to provide the first current when the first resistive device is enabled and the second resistive device is disabled; and control the current source circuit to provide the second current when the first resistive device is disabled and the second resistive device is enabled.

Example 4. The apparatus of one of examples 1 to 3, further including a third resistive device coupled between the second and third terminals, where the current source circuit is configured to enable the third resistive device and provide a third current to the first terminal, the third current being sixteen times the first current and the second current being six times the first current.

Example 5. The apparatus of one of examples 1 to 4, where the control circuit is coupled to the third resistive device, and the control circuit is configured to: enable the third resistive device, disable the first and second resistive devices, and control the current source circuit to provide the third current; for each time the third resistive device is enabled, enable the second resistive device, disable the first and third resistive devices, and control the current source circuit to provide the second current three times; and for each time the third resistive device is enabled, enable the first resistive device, disable the first and third resistive devices, and control the current source circuit to provide the first current two times.

Example 6. The apparatus of one of examples 1 to 5, further including an analog-to-digital converter (ADC) having an input coupled to the first terminal.

Example 7. The apparatus of one of examples 1 to 6, where the ADC is an integrating ADC.

Example 8. The apparatus of one of examples 1 to 7, where the control circuit is coupled to the ADC and is configured to: cause the ADC to provide a first ADC conversion while the current source circuit provides the first current to the first terminal; cause the ADC to provide a second ADC conversion while the current source circuit provides the second current to the first terminal; and determine a value indicative of temperature based on the first and second ADC conversions.

Example 9. The apparatus of one of examples 1 to 8, where the first resistive device has a first resistance, and the second resistive device has a second resistance that is different than the first resistance.

Example 10. The apparatus of one of examples 1 to 9, where: the first resistive device includes a first resistor coupled to a first switch; and the second resistive device includes a second resistor coupled to a second switch.

Example 11. The apparatus of one of examples 1 to 10, where: the first switch has a first control terminal coupled to the control circuit; and the second switch has a second control terminal coupled to the control circuit.

Example 12. The apparatus of one of examples 1 to 11, where the first and second resistors are trimmable.

Example 13. The apparatus of one of examples 1 to 12, further including a temperature-sensitive device having a first temperature-sensitive device terminal coupled to the first terminal and having a second temperature-sensitive device terminal coupled to the second terminal.

Example 14. The apparatus of one of examples 1 to 13, where the current source circuit and first and second resistive devices are on a first integrated circuit, and the temperature-sensitive device is on a second integrated circuit.

Example 15. The apparatus of one of examples 1 to 14, where the temperature-sensitive device includes a bipolar junction transistor having a base coupled to the second terminal, and an emitter coupled to the first terminal.

Example 16. The apparatus of one of examples 1 to 15, further including another temperature-sensitive device including another bipolar junction transistor having a base coupled to the first terminal and an emitter coupled to the second terminal.

Example 17. An apparatus, including: a first current source having an output coupled to a first terminal; a second current source having an output coupled to the first terminal; a third current source having an output coupled to the first terminal; a first controllable resistive device coupled between a second terminal and a ground terminal, the first controllable resistive device having a first resistance; a second controllable resistive device coupled between the second terminal and the ground terminal, the second controllable resistive device having a second resistance different from the first resistance; a third controllable resistive device coupled between the second terminal and the ground terminal, the third controllable resistive device having a third resistance different from the first and second resistances; and an analog-to-digital converter (ADC) having an input coupled to the first terminal.

Example 18. The apparatus of example 17, where: the first controllable resistive device includes a first resistor coupled to a first switch; the second controllable resistive device includes a second resistor coupled to a second switch; and the third controllable resistive device includes a third resistor coupled to a third switch.

Example 19. The apparatus of one of examples 17 or 18, further including a control circuit coupled to the first, second, and third current sources, where: the first switch has a first control terminal coupled to the control circuit; the second switch has a second control terminal coupled to the control circuit; and the third switch has a third control terminal coupled to the control circuit.

Example 20. The apparatus of one of examples 17 to 19, where the first, second, and third resistors are trimmable.

Example 21. The apparatus of one of examples 17 to 20, where the first switch includes a first transistor, the second switch includes a second transistor, and the third switch includes a third transistor.

Example 22. The apparatus of one of examples 17 to 21, further including a temperature-sensitive device having a first temperature-sensitive device terminal coupled to the first terminal and having a second temperature-sensitive device terminal coupled to the second terminal.

Example 23. The apparatus of one of examples 17 to 22, where the first, second, and third current sources, and the first, second, and third controllable resistive devices are on a first integrated circuit, and the temperature-sensitive device is on a second integrated circuit.

Example 24. The apparatus of one of examples 17 to 23, where the temperature-sensitive device is a bipolar junction transistor (BJT).

Example 25. The apparatus of one of examples 17 to 24, further including: a first bipolar junction transistor (BJT) having a first emitter coupled to the first terminal and a first base coupled to the second terminal; and a second BJT having a second emitter coupled to the second terminal and a second base coupled to the first terminal.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter. The gate, source, and drain of a FET and base, collector, and emitter of a BJT are terminals of the transistor.

Circuits described herein may be reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description may include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

While this disclosure has been described with reference to illustrative embodiments, this description is not limiting. Various modifications and combinations of the illustrative embodiments, as well as other embodiments, will be apparent to persons skilled in the art upon reference to the description.

What is claimed is:

1. An apparatus, comprising:
a current source circuit having an output coupled to a first terminal;
a first resistive device coupled between second and third terminals;
a second resistive device coupled between the first and second terminals; and
a control circuit coupled to the current source circuit and to the first and second resistive devices, the control circuit configured to:
enable the first resistive device and control the current source circuit to provide a first current to the first terminal; and
enable the second resistive device and control the current source circuit to generate a second current to the first terminal, the second current being different than the first current.

2. The apparatus of claim 1, wherein the second current is six times the first current.

3. The apparatus of claim 1, wherein the control circuit is configured to:
control the current source circuit to provide the first current when the first resistive device is enabled and the second resistive device is disabled; and
control the current source circuit to provide the second current when the first resistive device is disabled and the second resistive device is enabled.

4. The apparatus of claim 1, further comprising a third resistive device coupled between the second and third terminals, wherein the current source circuit is configured to enable the third resistive device and provide a third current to the first terminal, the third current being sixteen times the first current and the second current being six times the first current.

5. The apparatus of claim 4, wherein the control circuit is coupled to the third resistive device, and the control circuit is configured to:
enable the third resistive device, disable the first and second resistive devices, and control the current source circuit to provide the third current;
for each time the third resistive device is enabled, enable the second resistive device, disable the first and third resistive devices, and control the current source circuit to provide the second current three times; and
for each time the third resistive device is enabled, enable the first resistive device, disable the first and third resistive devices, and control the current source circuit to provide the first current two times.

6. The apparatus of claim 1, further comprising an analog-to-digital converter (ADC) having an input coupled to the first terminal.

7. The apparatus of claim 6, wherein the ADC is an integrating ADC.

8. The apparatus of claim 6, wherein the control circuit is coupled to the ADC and is configured to:
cause the ADC to provide a first ADC conversion while the current source circuit provides the first current to the first terminal;
cause the ADC to provide a second ADC conversion while the current source circuit provides the second current to the first terminal; and
determine a value indicative of temperature based on the first and second ADC conversions.

9. The apparatus of claim 1, wherein the first resistive device has a first resistance, and the second resistive device has a second resistance that is different than the first resistance.

10. The apparatus of claim 1, wherein:
the first resistive device includes a first resistor coupled to a first switch; and
the second resistive device includes a second resistor coupled to a second switch.

11. The apparatus of claim 10, wherein:
the first switch has a first control terminal coupled to the control circuit; and
the second switch has a second control terminal coupled to the control circuit.

12. The apparatus of claim 10, wherein the first and second resistors are trimmable.

13. The apparatus of claim 1, further comprising a temperature-sensitive device having a first temperature-sensitive device terminal coupled to the first terminal and having a second temperature-sensitive device terminal coupled to the second terminal.

14. The apparatus of claim 13, wherein the current source circuit and first and second resistive devices are on a first integrated circuit, and the temperature-sensitive device is on a second integrated circuit.

15. The apparatus of claim 13, wherein the temperature-sensitive device comprises a bipolar junction transistor having a base coupled to the second terminal, and an emitter coupled to the first terminal.

16. The apparatus of claim 14, further comprising another temperature-sensitive device comprising another bipolar junction transistor having a base coupled to the first terminal and an emitter coupled to the second terminal.

17. An apparatus, comprising:
a first current source having an output coupled to a first terminal;
a second current source having an output coupled to the first terminal;
a third current source having an output coupled to the first terminal;
a first controllable resistive device coupled between a second terminal and a ground terminal, the first controllable resistive device having a first resistance;
a second controllable resistive device coupled between the second terminal and the ground terminal, the second controllable resistive device having a second resistance different from the first resistance;
a third controllable resistive device coupled between the second terminal and the ground terminal, the third controllable resistive device having a third resistance different from the first and second resistances; and
an analog-to-digital converter (ADC) having an input coupled to the first terminal.

18. The apparatus of claim 17, wherein:
the first controllable resistive device includes a first resistor coupled to a first switch;
the second controllable resistive device includes a second resistor coupled to a second switch; and
the third controllable resistive device includes a third resistor coupled to a third switch.

19. The apparatus of claim 18, further comprising a control circuit coupled to the first, second, and third current sources, wherein:
the first switch has a first control terminal coupled to the control circuit;
the second switch has a second control terminal coupled to the control circuit; and
the third switch has a third control terminal coupled to the control circuit.

20. The apparatus of claim 18, wherein the first, second, and third resistors are trimmable.

21. The apparatus of claim 18, wherein the first switch comprises a first transistor, the second switch comprises a second transistor, and the third switch comprises a third transistor.

22. The apparatus of claim 17, further comprising a temperature-sensitive device having a first temperature-sensitive device terminal coupled to the first terminal and having a second temperature-sensitive device terminal coupled to the second terminal.

23. The apparatus of claim 22, wherein the first, second, and third current sources, and the first, second, and third controllable resistive devices are on a first integrated circuit, and the temperature-sensitive device is on a second integrated circuit.

24. The apparatus of claim 22, wherein the temperature-sensitive device is a bipolar junction transistor (BJT).

25. The apparatus of claim 17, further comprising:
a first bipolar junction transistor (BJT) having a first emitter coupled to the first terminal and a first base coupled to the second terminal; and
a second BJT having a second emitter coupled to the second terminal and a second base coupled to the first terminal.
